(19) United States
(12) Patent Application Publication
(10) Pub. No.: US 2001/0024509 A1
(43) Pub. Date: Sep. 27, 2001

(54) Subwoofer with active and passive drivers

(76) Inventor: Robert W. Carver, Snohomish, WA (US)

Correspondence Address: ROBERT B. HUGHES, HUGHES & SCHACHT, P.S., 2801 MERIDIAN STREET, SUITE 1, BELLINGHAM, WA, 98225-2412, US

(21) Appl. No.: 09/757,120

(22) Filed: Jan. 8, 2001

Related U.S. Application Data
(63) Continuation-in-part of application No. 09/370,452, filed on Aug. 9, 1999.
Application No. 09/370,452 is a continuation of application No. 08/909,892, filed on Aug. 12, 1997, now Pat. No. 5,937,074.
(60) Provisional application No. 60/175,119, filed on Jan. 6, 2000.
(60) Provisional application No. 60/023,784, filed on Aug. 12, 1996.
(60) Provisional application No. 60/175,119, filed on Jan. 6, 2000.

(51) Int. Cl. H04R 25/00; H04R 1/02

(52) U.S. Cl. 381/395; 381/150; 381/386; 181/148; 181/199

(57) ABSTRACT

A woofer apparatus having a cabinet defining a chamber, a magnet, a voice coil member positioned to reciprocate in the magnetic field of the magnet, a speaker diaphragm, and a passive radiator diaphragm. The components are arranged so that the maximum box pressure during maximum displacement mode of operation is greater than 0.2 psi. the tuned frequency of the apparatus is, in a preferred mode, at about 35 Hz, so that the passive radiator has substantially greater maximum excursion strokes at maximum displacement than the speaker diaphragm.

### CROSS REFERENCE TO RELATED APPLICATIONS

This Application claims the priority of U.S. Provisional Application 60/175,119, filed on Jan. 6, 2000, entitled “Subwoofer With Active and Passive Drivers. This Application is also a continuation in part, and claims the priority of U.S. patent application Ser. No. 09/370,452, filed on Aug. 9, 1999, which is in turn a continuation of U.S. patent application Ser. No. 08/909,892, filed Aug. 12, 1997 (now U.S. Pat. No. 5,937,074), which in turn claims the benefit of Provisional Application Ser. No. 60/023,784, filed Aug. 12, 1996.

### BACKGROUND OF THE INVENTION

A Field of the Invention

The present invention relates to audio equipment, and more particularly to audio equipment to reproduce sound in the low frequency range (i.e. a subwoofer) and more particularly to a subwoofer having at least one active driver and at least one passive driver.

B) Background Art

Some subwoofers are designed so that there is at least one active driver and one passive driver. The active driver comprises a speaker cone and a voice coil, with the speaker cone moving back and forth in a magnetic field in response to the current that is passed through the voice coil. The passive driver also has a speaker cone, and attached to the speaker cone is a mass which provides inertial forces which result in the proper back and forth motion of the passive driver. The active and passive drivers are mounted in an enclosed box or cabinet. The drivers operate in a push pull pattern so that the two drivers move inwardly to compress the air in the cabinet chamber on one half cycle and move outwardly on the other half cycle to lower the pressure in the cabinet chamber.

The two drivers, along with the air in the chamber, effectively comprise a spring mass system, with the passive driver being the mass, the air in the chamber being the spring, and the active driver being the active member which applies force in a back and forth pattern to cause the oscillations.

For any spring mass system (whether it be a subwoofer with active and passive drivers or some other system) there is what is called a “resonant frequency”. If the active member is moved back and forth at a frequency below the resonant frequency, the mass will be “out of phase” with the movement of the active member. For example, let us consider a very simple spring mass system where one end of a coil spring is held in a person's hand, and a weight is attached to the other end of the coil spring. If the person moves his hand up and down rather slowly (i.e. below the resonant frequency), the spring will cause the weight to move upwardly as the person's hand moves upwardly and also will move downwardly as the person's hand moves downwardly. However, let us assume that the person starts moving his hand up and down more rapidly. At a certain point, the resonant frequency will be reached, and then the back and forth movement of the person's hand and the back and forth movement of the mass will almost immediately begin moving “in phase”. In other words, as a person is moving his hand upwardly, the mass is moving downwardly, and then as a person moves his hand downwardly, the spring will be moving upwardly.

To relate this to the operation of a subwoofer having active and passive drivers, at such time as the movement of the active driver is at the resonant frequency, then the movement of the active and passive drivers will be “in phase” (i.e. they move inwardly during the same half cycle and outwardly on the same half cycle). However, this is not entirely accurate, since if there is some damping in the system (e.g. caused by frictional losses), there will be a certain amount of lag.

Mathematically, the resonant frequency is proportional to the square root of K over m, where “K” is the spring constant and “m” is the mass. The spring constant (K) is in turn equal to the change of force exerted by the spring over a certain distance divided by that distance. When we relate this to the passive driver in a subwoofer it becomes evident that as the mass of the passive driver increases, the resonant frequency decreases. In like manner, as the force generated by the “spring” (in this case the air volume within the cabinet) increases for a given amount of displacement, the resonant frequency increases.

In any spring mass system, once the resonant frequency has been reached, if the frequency of the back and forth movement of the active member increases, the relative distance of the back and forth movement of the active and passive member will also change. In general, at the resonant frequency, there will be a much greater back and forth movement of the passive member than movement of the active member. As the frequency increases, then the movement of the active member relative to the movement of the passive member will increase.

In other instances, it is sometimes desirable to achieve certain design objectives by not having the combination of an active driver and a passive driver. Rather, there is provided only one or more voice coil driven drivers.

In my recently issued U.S. patent (U.S. Pat. No. 5,937,074), there is introduced a number of new design concepts, and these are combined in such a way as to provide a subwoofer having a high acoustic output and yet relatively small volume. Within the scope of the various design concepts contained in that patent, there are possibilities of a number of design configurations and modifications.

It is an object of the present invention to provide at least a couple of design concepts which employ at least in part the novel concepts disclosed in my previous patents.

### SUMMARY OF THE INVENTION

The woofer apparatus of the present invention is utilized for processing an audio signal. The apparatus comprises a cabinet having a chamber of predetermined air volume, and a magnet which is mounted to the apparatus and establishes a magnetic field of a predetermined flux density.

There is a voice coil member positioned to reciprocate in the magnetic field through maximum peak-to-peak excursion strokes during peak acoustic displacement of the apparatus, and having a voice coil adapted to be connected to an amplifier.

A speaker diaphragm is connected to the voice coil member for reciprocating motion therewith through said peak-to-peak excursion strokes during peak acoustic displacement of the apparatus. A suspension is provided for supporting the speaker diaphragm and the voice coil member from the cabinet for reciprocation relative to the magnet.

There is a passive radiator diaphragm positioned to reciprocate through maximum peak-to-peak excursion strokes during peak acoustic displacement of the apparatus.

The apparatus is structured and configured so that as the speaker diaphragm with the voice coil member and the passive radiator diaphragm reciprocate during maximum cabinet pressure mode of operation, the total of the effective area of the passive radiator diaphragm times its peak-to-peak excursion stroke plus the effective area of the speaker diaphragm times its peak-to-peak excursion stroke, relative to the flux density of the magnetic field, the air volume of the cabinet, the effective length of the voice coil and peak current therein, is such that the maximum box pressure is greater than 0.2 psi, and desirably substantially greater than 0.2 psi. Also, the mass of the passive radiator diaphragm and the box pressure developed is such that the tuning frequency is between about 25 to 55 Hz. More desirably, the tuning frequency is between about 25 to 50 Hz, and more preferably between 30 Hz to 45 Hz, and yet more desirably between 30 Hz to 40 Hz. A preferred tuning frequency is approximately 35 Hz.

Other features will become apparent from the following description.

### BRIEF DESCRIPTION OF THE DRAWINGS

FIG. 1 is a sectional view, drawn partly in section, of the subwoofer of the present invention; and

FIG. 2 is a sectional view showing the active driver of the present invention.

### DESCRIPTION OF THE PREFERRED EMBODIMENTS

A first embodiment of the present invention is related in a number of ways to the design of the subwoofer disclosed in my issued patent U.S. Pat. No. 5,937,074. As indicated previously in this text, one of the main objectives in that patent is to substantially decrease the box size while providing a relatively high acoustic output. This requires higher than normal box pressure be developed, and in an optimized design where the size of the box is substantially reduced, there is developed a relatively high maximum box pressure. A number of design features are combined to obtain these objectives.

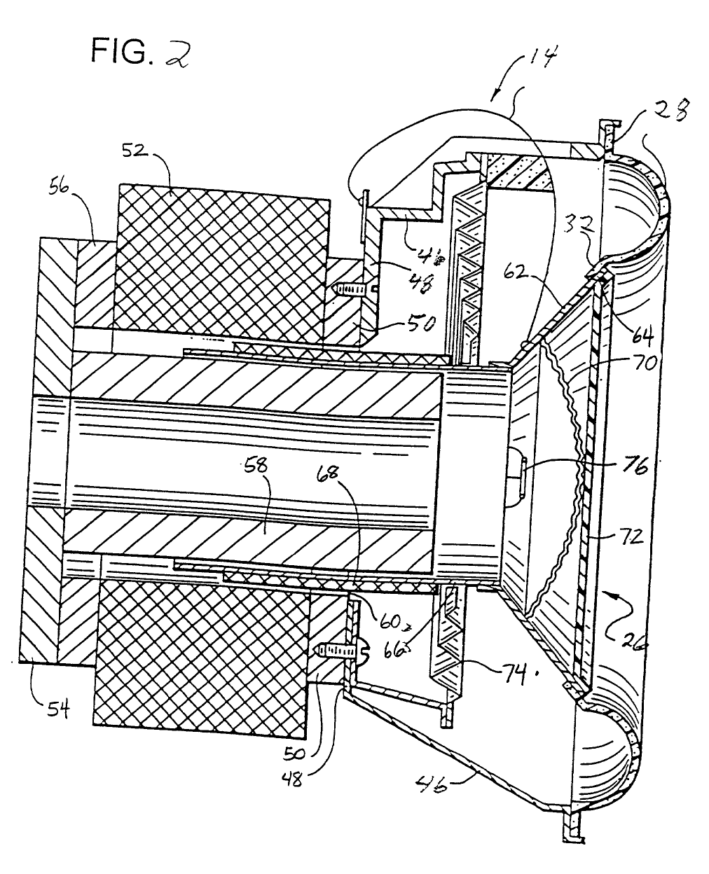

The subwoofer disclosed in my patent embodies active and passive drivers, and has a basic design which could be adapted to incorporate the teachings of the present invention. For this reason, I have selected the subwoofer which is shown in FIGS. 2 and 3 and described in my issued patent to disclose this first embodiment of the present invention of this patent application.

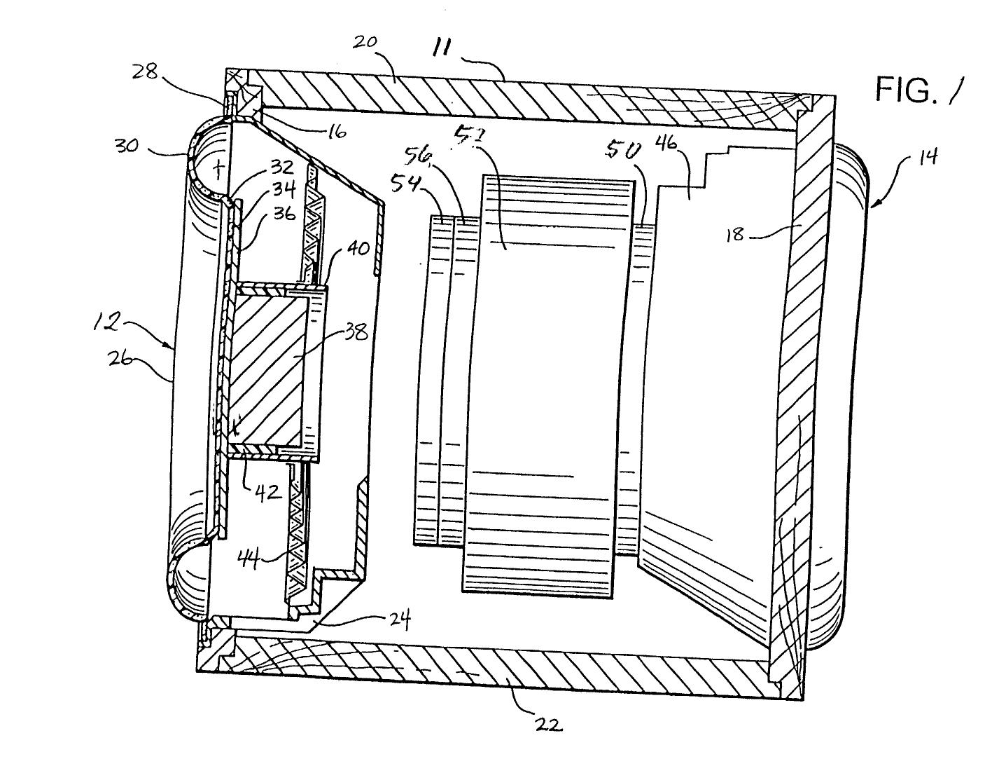

The subwoofer 10 includes a cabinet 11 which encloses two drivers, 12 and 14, which are each oriented in a PUSH/PULL configuration on opposite sides of the cabinet 11. The driver 12 is a passive driver and is mounted in the left wall 16 (as seen in FIG. 1) of the cabinet 11 (as viewed in FIG. 1). The second driver 14 is mounted in the opposite or right sidewall 18 of the cabinet 11. As will be described later herein, both drivers 52, 54 move simultaneously in a PUSH (or outward) direction and simultaneously in a PULL (or inward) direction.

The cabinet 11 is in this particular embodiment a substantially cubic structure and comprises the two aforementioned walls 16 and 18, a top wall 20, a bottom wall 22 and two side walls (not shown).

With reference to FIG. 1 the passive driven woofer 12 includes a stationary frame or cage 24 mounted in the left sidewall 16 of the cabinet 11 for resiliently supporting the moving driver components in a stable manner wherein the movable driver components are constrained for PUSH/PULL movement axially out of the axially into the cabinet. The movable driver components in the passive driven driver comprise: a resilient, but semi-rigid, high pressure resistant surround 26 formed of an expanded synthetic cellular foam, having an outer peripheral circumferential flange 28 an annular half roll or “edgeroll” 30 integral with the flange 28 and terminating in an inner annular inturned or downturned integral flange 32 which is, in turn, integral with a flat central disk portion 34. A rigid backing plate 36 formed of paperboard, plastic or the like is adhesively bonded to the central disk portion 34 of the surround 26. A round rod-shaped metal mass 38 is secured to the backing plate 36 within a cardboard or paperboard cylindrical tube 40 by means of a suitable epoxy glue 42. The movable components of the passive driver 12 include an annular flexible spider 44 having a corrugated cross-sectional configuration wherein the corrugations get progressively deeper towards the outer periphery of the spider 44. The outer periphery of the spider 44 is fixedly secured to the frame or cage 25 of the passive driver 52, while its inner periphery is fixedly secured to the cylindrical cardboard or paperboard tube 40 surrounding the mass 38.

The active driver 14 includes a stationary basket-like frame or cage 46 which is fixedly mounted in the right wall 18 of the cabinet 11 as viewed in FIG. 1. The base of the frame 46 comprises an annular washer-shaped flange 48 which is secured to an annular metal topspacer 50 which is positioned adjacent to an annular magnet 52. The inner face of the annular magnet 52 is spaced from an annular metal bottom plate 54 by an annular spacer 56. The final stationary member of the active driver 12 comprises an annular pole piece 58. The arrangement is such that the outer diameter of the annular pole piece 58 defines an annular gap 60—termed the “magnetic gap”—between the pole piece 58 and the annular spacer 52.

The movable components of the active driver 14 comprise: i) an expanded synthetic cellular foam surround 28′ which is substantially identical to the surround 28 employed with the passive driver 12 previously described 3except that the central disk-shaped portion 34 of the surround 28 associated with the passive woofer 52 has been removed in the surround 38′ employed with the active driver 14; ii) a speaker cone 62 having a funnel shape with its outer large diameter end 64 being adhesively bonded or otherwise fixedly secured to the inner inturned flange 32 on the surround 28′; iii) a cylindrical voice coil former 66 having an inner diameter slightly greater than the outer diameter of the annular pole piece 58; iv) a voice coil 68 wound about the voice coil former 66 and having an outer diameter slightly less than the inner diameter of the annular spacer 50; v) a rigid dust cover or surround support 70 having a shape comprising a segment of a sphere which is positioned within, and secured to, the funnel-shaped speaker cone 62 with the domed portion of the dust cover/support facing outwardly; vi) a decorative cover 72 formed of expanded cellular polyethylene (“PE”) surround foam, or similar material, positioned within, and secured to, the outermost large diameter end 64 of the speaker cone 62 with the decorative cover 72 abutting the dust cover/support at their respective midpoints; and vii) an annular spider 74 having a corrugated cross section wherein the depth of the corrugations progressively increase from the inner periphery towards the outer periphery with the spider 74 being secured at its innermost periphery to the outer surface of the voice coil former 66 and at its outer periphery to the frame or cage 46 of the apparatus.

When current flows through the voice coil 68 creating magnetic fields around the voice coil, these voice coil magnetic fields interact with the magnetic field of the magnet 52, causing the voice coil former 66, voice coil 68, speaker cone 62, dust cover 70, surround 28′, decorative cover 72 and spider 74 to move in an axial direction.

The above description discloses the basic physical components of the subwoofer itself. The information contained in that issued patent is incorporated by reference in the present specification, but for the sake of brevity, this is not repeated herein, but rather the entire text and drawings of the application are added hereto and made part of this disclosure.

To discuss now features of the first embodiment of the present invention, for reasons which will become more apparent later in this discussion, the components and operating parameters are arranged so that the tuning frequency has a lower limit of twenty-five Hz or possibly thirty Hz, an upper limit of broadly fifty-five Hz, or more narrowly fifty, forty-five or forty Hz. Present analysis indicates that a tuning frequency of approximately thirty-five Hz would be desirable. However, again depending upon certain objectives, this could be varied within the various limits described above.

To accomplish this, we first look at the total mass of the passive driver which in other subwoofers could have a tuning frequency of twenty Hz. As indicated previously, if the mass of the passive driver is decreased, the effect of this is to raise the tuning frequency. Also, if the spring constant increases, the tuning frequency increases. Since the tuning frequency is dependent upon the force of the “spring” (in this case the air in the box chamber), it would be expected that with a lower box volume and with a given displacement, this “spring constant” of this system might increase.

Accordingly, if one begins with a design of a subwoofer that has a tuning frequency of twenty Hz, if the box pressure is to remain constant, then the mass of the passive driver would be decreased to increase the tuning frequency. For the moment, let us assume that the volume of the chamber and the displacement achieved by the active and passive drivers is selected in combination with the mass of the passive driver to achieve the thirty-five Hz tuning frequency.

It is also characteristic of a spring mass system that when it is operating at the tuning frequency or slightly above the tuning frequency, the movement of the active driver is relatively small compared to the movement of the passive driver. Also, it is to be recognized that for most music, the predominant low frequency sound components are in the thirty-five Hz range, and seldom down to the twenty Hz range.

To obtain a desired relatively large acoustic displacement at thirty-five Hz, it would of course be necessary to have sufficiently large total movement of the active and passive drivers. For example, let it be assumed that the areas of the two passive drivers are each 100 square inches, and it is desired at thirty-five Hz to have total displacement of three hundred cubic inches. This would require a total stoke of three inches of the active and passive drivers. At thirty-five Hz, it could be that the movement of the active driver would be one fifth the movement of the passive driver, so that the back and forth excursion of the active driver would be 0.5 inch while the excursion of the passive driver would be 2.5 inch.

Now let us assume that the subwoofer is operating at a higher frequency of, for example, fifty Hz. Due to the inherent characteristics of the spring mass system, the excursion of the active driver would increase for the same acoustic displacement, while that of the passive driver would decrease. To achieve the same acoustic displacement of three hundred cubic inches, it would thus be necessary for each of the drivers to have a back and forth excursion of 1.5 inches.

However, for higher frequencies, if there is a given air displacement on each cycle, the total air displacement for a given increment of time increases proportionately with the rise of the frequency. Therefore, it is usually possible (or more likely desirable for the proper production of the musical sound) to have substantially smaller acoustic displacement for each cycle at higher frequencies. Thus, the total air displacement may be as low as one hundred cubic inches per cycle (even for very loud music) at fifty Hz. This can be accomplished by establishing upper limits to the audio signal in that frequency range.

For frequencies below the resonant frequency, the active and passive driver go out of phase so that these work in a pattern which more closely resembles back and forth movement where one is moving into the cabinet chamber and the other is moving out. Thus, the acoustic displacement diminishes very rapidly at those frequencies, and for all practical purposes the sound at those frequencies are not reproduced at an adequate amplitude.

Therefore, at operating at the above design parameters there can be achieved a quite adequate reproduction of the sound components of the lower frequencies without any significant loss of quality. Also the total excursion of the active driver could be maintained at a moderate level, and this may have advantages in certain design configurations. This is achieved by selecting the mass of the passive driver and selecting the design components responsible for the “spring constant” of the subwoofer to maintain the excursion of the active driver within the desired limits.

In a second embodiment of the present invention, the passive driver is not incorporated in the system. Rather, there is one or more voice coil driven drivers which by themselves could supply the desired acoustic output. Also, in the second embodiment, some of the basic design principals of my previously U.S. patent are incorporated. As in my recent issued patent, one of the objectives is to obtain a relatively small box size while still achieving a desired level of acoustic displacement.

As indicated in my previously issued patent under the discussion of the prior art, traditionally subwoofers having high acoustic output would have very large boxes. The acceptable pressure developed in the box was in the range of 0.05 up to possibly and approaching 0.2 pounds per square inch. However, to obtain further reductions in box size and yet obtain the desired acoustic output, it becomes necessary to substantially increase the box pressure. In accordance with the prior art teachings, this was not possible.

In the second embodiment of the present invention, it is assumed that there are certain design objectives where it is desired to have a relatively small box volume, and yet high acoustic output relative to that box volume. This automatically means higher box pressure and this would mean that for a voice coil driven driver having a designated stroke and diaphragm area, the back pressure would be increased, which would in turn mean that the power delivered by the voice coil should be increased. Normally, this would mean increasing the current in the voice coil. For various reasons, this is for most all designs not a viable option. Also, for various design reasons, it may be desirable to maintain the length of the stroke of the voice coil below certain limits.

In accordance with the present invention, the magnetic field created by the magnet is increased substantially to substantially increase the density of the magnetic field through which the voice coil moves. The amplifier is provided as a high power amplifier (such as in my recently issued patent) to provide sufficient voltage to overcome the high back-emf that is created by the much greater strength of the magnetic field through which the voice coil moves. To put this in a practical framework, let it be assumed, for example, that it is desired to provide a subwoofer that has a very small dimension in a direction that is parallel to the movement of the voice coil. In this instance, to accomplish the overall design objectives, it may desirable (as indicated above) to maintain the back and forth movement of the diaphragm within lower limits and yet increase the area of the diaphragm or diaphragms. Further analysis has indicated that that is possible by increasing the strength of the magnetic field several times over, to provide the high back-emf, but still to provide the adequate power to overcome the higher than normal box pressure.

More specifically, this design can be incorporated to provide a subwoofer having adequate acoustic output having box pressure in excess of 0.2 pounds per square inch, and also substantially in excess of 0.2 pounds per square inch, such as 0.3, 0.4, 0.6, 0.8, or 1 pound per square inch or higher.

It is obvious that various modifications could be made to the present invention without departing from the basic teachings thereof.

1. A woofer apparatus for processing an audio signal, said apparatus comprising:
a) a cabinet having a chamber of a predetermined air volume;
b) a magnet which is mounted to said apparatus and which establishes a magnetic field of a predetermined flux density;
c) a voice coil member positioned to reciprocate in said magnetic field through maximum peak-to-peak excursion strokes during peak acoustic displacement of the apparatus and having a voice coil adapted to be connected to an amplifier;
d) speaker diaphragm connected to said voice coil member for reciprocating motion therewith through said peak-to-peak excursion strokes during peak acoustic displacement of the apparatus;
e) suspension for supporting said speaker diaphragm and said voice coil member from said cabinet for reciprocation relative to said magnet;
f) a passive radiator diaphragm positioned to reciprocate through maximum peak-to-peak excursion strokes during peak acoustic displacement of the apparatus;
g) said apparatus being structured and configured so that as said speaker diaphragm with said voice coil member and the passive radiator diaphragm reciprocate during maximum cabinet pressure mode of operation, the total of the effective area of said passive radiator diaphragm times its peak-to-peak excursion stroke plus the effective area of said speaker diaphragm times its peak-to-peak excursion stroke, relative to the flux density (B) of the magnetic field, the air volume of the cabinet, the effective length ( [symbol] ) of the voice coil and peak current therein, is such that the maximum box pressure is greater than 0.2 psi, and the mass of the passive radiator diaphragm and the box pressure developed in the cabinet is such that a tuning frequency of the apparatus is between about 25 Hz to 55 Hz.

2. The apparatus as recited in claim 1, wherein said tuning frequency is between about 25 Hz to about 50 Hz.

3. The apparatus as recited in claim 1, wherein the tuning frequency is between about 30 Hz to about 45 Hz.

4. The apparatus as recited in claim 1, wherein the tuning frequency is between about 30 Hz to 40 Hz.

5. The apparatus as recited in claim 1, wherein the tuning frequency is approximately 35 Hz.

6. The apparatus as recited in claim 1, wherein said maximum box pressure is substantially greater than 0.2 psi.

7. The apparatus as recited in claim 6, wherein said tuning frequency is between about 25 Hz to about 50 Hz.

8. The apparatus as recited in claim 6, wherein the tuning the air volume of the cabinet, the effective length ( [symbol] ) of the

9. The apparatus as recited in claim 1, wherein the tuning frequency is between about 30 Hz to 40 Hz.

10. The apparatus as recited in claim 1, wherein the tuning frequency is approximately 35 Hz.
